(19) United States
(12) Patent Application Publication
(10) Pub. No.: US 2004/0010580 A1
(43) Pub. Date: Jan. 15, 2004

(54) Network administration/management utility

(76) Inventor: Edward George Falzon, Queensland (AU)

Correspondence Address: YOUNG & THOMPSON, 745 SOUTH 23RD STREET 2ND FLOOR, ARLINGTON, VA, 22202

(21) Appl. No.: 10/426,660

(22) Filed: May 1, 2003

(30) Foreign Application Priority Data
May 1, 2002 (AU) PS2056

(51) Int. Cl. G06F 15/173

(52) U.S. Cl. 709/223

(57) ABSTRACT

Provided is a network administration management utility for a hierarchical tree structure in an computer network. The utility comprises container selection means for selecting one or more containers from destination network sites in said tree structure, assigning means for assigning one or more macro reference for the selected container(s), and means for generating a configuration object (ZCO) having the corresponding macro reference(s) for each assigned container. The macro reference may include a macro value associated with a macro name which can be a source server, a source volume, a destination drive, a source drive, or a path for source drive. Object selection means is arranged for selecting one or more application objects, and distribution objects based on the source paths of the selected application objects are created. Set up is a file agent having target volumes corresponding to the source volumes of the selected application objects or a default macro value for the volumes. The file agent is used to distribute application files for the selected application objects for each destination container to the destinations.

Also provided is a deployment system for deploying application objects in an computer network having a hierarchical tree structure. The system is arranged to extract information from the ZCOs.

### FIELD OF THE INVENTION

THIS INVENTION relates to a network administration/management utility particularly suited for but not limited to an NDS (Novell Directory Services) environment.

### BACKGROUND OF THE INVENTION

Computer networks often include multiple servers each serving multiple workstations known as “clients”. Under an NDS environment, applications are managed through the use of application objects in a hierarchical directory services database.

A network administrator is usually responsible for maintaining the database and applications running on the network up to date. Tools such as Novell's ZENworks® (ZENworks® is the registered trade mark of Novell Inc), TED (Tiered Electronic Distribution), Netware Administrator (NW Admin) and ConsoleOne, have been developed to enable a network administrator to maintain a network from a single point in the network typically involving copying and upgrading processes. Generally speaking none of these are able to automate deployment and upgrade operations.

The applicant's co-pending U.S. patent application Ser. No. 09/895,200 filed on Jul. 2, 2001 teaches a network administration management utility that provides some automatic functionalities to simplify many tasks required in administering a network. The entire disclosure in Ser. No. 09/895,200 is hereby incorporated herein by reference. This utility allows a user to select source objects for creating an object list and to select destinations for creating a destination list. The utility then automatically processes selected deployment operations in accordance with the created lists.

### OBJECT OF THE INVENTION

It is an object of the present invention to provide an improved network ad ministration/management utility.

### SUMMARY OF THE INVENTION

In one aspect therefore the present invention provides a network administration management utility for a hierarchical tree structure in an computer network, the utility comprising container selection means for selecting one or more containers from destination network sites in said tree structure, assigning means for assigning one or more macro reference for the selected container(s), and means for generating a configuration object (ZCO) having the corresponding macro reference(s) for each assigned container.

Preferably, said macro reference includes a macro value associated with a macro name. The macro name may be a source server, a source volume, a destination drive, a source drive, or a path for source drive.

It is further preferred that the utility includes updating means for updating the macro reference(s) of the configuration object.

The utility may also include object selection means arranged for selecting one or more application objects, means for creating distribution objects based on the source paths of the selected application objects, and means for setting up a file agent having target volumes corresponding to the source volumes of the selected application objects or a default macro value for the volumes. The file agent is used to distribute application files for the selected application objects for each destination container to the destinations.

The utility may further include means for creating channels associated with the distribution objects and subscribers in the destination containers.

In a second aspect there is provided a deployment system for deploying application objects in an computer network having a hierarchical tree structure. The system comprises:

means for selecting one or more application objects each having a source path and a source volume;

means for selecting one or more destination containers;

means for creating distribution objects based on the source paths of the selected application objects;

means for setting up a file agent having target volumes corresponding to the source volumes of the selected application objects or a default macro value for the volumes; and

means for creating channels associated with the distribution objects and subscribers in the destination containers

Said application objects selection means may be arranged to select source application objects from single or multiple containers in a single or multiple source tree, and said destination objects selection means may be arranged to select destination containers from single or multiple containers in a multiple tree.

Said means for creating distribution objects may be arranged to find distributors for all selected applications and to create distribution objects from the same distributors in the distribution containers. The distributors may also be grouped into virtual distribution groups.

The means for setting up a file agent can be arranged to add a destination volume variable for a target volume, and to add a source path from source applications to determine target application files in the file agent. Hence different subscribers may have their individual define target volume that is corresponding to the source path macro in destination applications.

This variable may be extracted from the correspond macro reference of the ZCO of the above described utility. If ZCO does not exists the system is arranged to use a preassigned default volume such as “SYS”. If the volume variable does not exists in a subscriber, the system is arranged for creating a volume variable for the subscriber.

The means for setting up a file agent can also be arranged to associate distributor to distribution object and set up the file agent for applications in the same distribution virtual group.

The means for creating channels may be arranged to create channel objects for source applications in their distributor containers, and to associate the channel objects to subscriber objects of destination containers.

Preferably, the invention further comprises a graphical user interface having a window showing a selected object tree and respective object and destination list windows.

### BRIEF DESCRIPTION OF THE DRAWINGS

FIG. 1 is a screen shot of the basic program interface illustrating six separate windows which the administrator can move and resize and select operations for activation;

FIG. 2 is a screen shot of the window interface showing the “Relative Macros” utility, and FIG. 3 shows processing steps in creating and maintaining the macros;

FIG. 4 is a screen shot of the window interface showing the “Auto-Configuration Options” of the “Relative Macros” utility shown in FIG. 2;

FIGS. 5-11 are flow diagrams showing the various means for creating

FIG. 12 is an overview block diagram showing server objects relation of a known network administration tool;

FIG. 13 shows block diagrams of the system according to the present invention;

FIG. 14 is a screen shot of a window showing a status report form of the system shown in FIG. 13;

FIG. 15 is a screen shot of a message window for polling process indications of the system shown in FIG. 13;

FIG. 16 is a flow diagram showing operation processes of the system shown in FIG. 13;

FIG. 17 is a flow diagram showing the process steps for the initialisation process of the system processes shown in FIG. 16;

FIG. 18 is a flow diagram showing the process steps for processing distribution records of the system processes shown in FIG. 16;

FIG. 19 is a flow diagram showing the process steps for processing subscriber records of the system processes shown in FIG. 16;

FIG. 20 is a flow diagram showing the process steps for processing target subscriber volume variables shown in FIG. 19;

FIG. 21 is a flow diagram showing the process steps for processing distribution according to the system processes shown in FIG. 16;

FIG. 22 is a flow diagram showing the process steps for creating distribution objects shown in FIG. 21;

FIG. 22A is a flow diagram showing the process steps for distribution options shown in FIG. 21;

FIG. 23 is a flow diagram showing the process steps for setting up file agent of distribution object shown in FIG. 21;

FIG. 24 is a flow diagram showing the process steps for processing channel according to the system processes shown in FIG. 16;

FIG. 25 is a flow diagram showing the process steps for creating channel shown in FIG. 24;

FIG. 26 is a flow diagram showing the process steps for processing external subscriber shown in FIG. 24;

FIG. 27 is a flow diagram showing the process steps for processing deployment according to the system processes shown in FIG. 16;

FIG. 28 is a flow diagram showing the steps for processing polling according to the system processes shown in FIG. 16;

FIG. 29 is a flow diagram showing the process steps for deployment with associations according to the system processes shown in FIG. 16; and

FIG. 30 is a flow diagram showing the process steps for processing the distribution options shown in FIG. 19.

### METHOD OF PERFORMANCE

Referring to the drawings, a preferred embodiment of the invention will now be described. The following example is in relation to an NDS (Novell Directory Services) environment but the invention is not so limited as the invention may be applied to any network, consequently the expression “object” should also be considered a non-limiting reference to any entity created for computing purposes that may be distributed across a network.

The program need only be installed on one workstation in a network. It need not be installed on a server. All that is required is that the administrator have authorization to browse all trees where operations are to be performed.

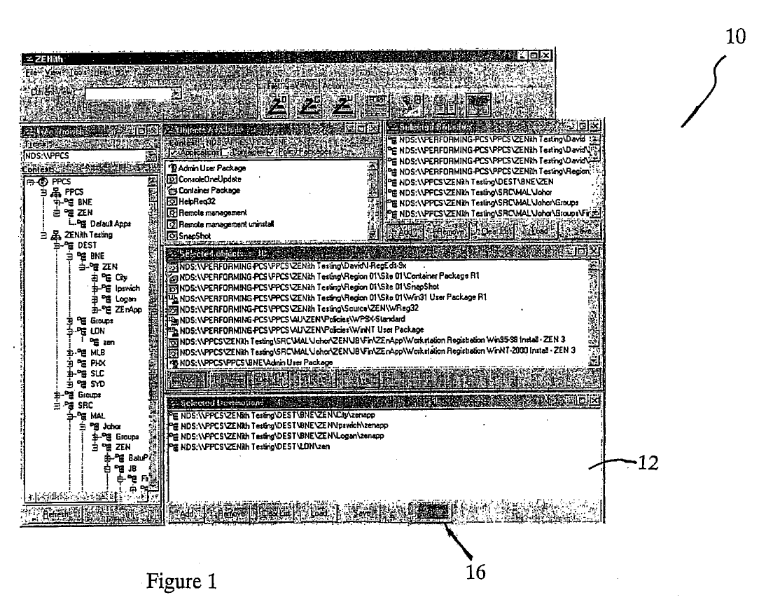

Referring to FIG. 1, when the utility/system 10 of the present invention is running, objects available appear automatically in the “object available” window according the highlighted selection in the “Tree Browse” window. In this example “BNE” has been selected. Objects, destinations and branches may be added to the corresponding windows by highlighting a selection in the “Tree Browse” window or in the “objects available” window and clicking the corresponding “Add” button. Lists may be saved for future use. Branches that are to be searched or otherwise interrogated as part of the field management program may be selected and added to the “selected branches” window.

A saved list may be loaded into any of the three windows for later execution. UNC format is employed.

To deploy source objects once the administrator has added entries in the “selected objects” window or loads a list and then adds destinations in the “selected destinations” window or loads a list he simply clicks a button of the “ACTION” tab to deploy with all selected options for deployment. Options are selected from other windows described as follows.

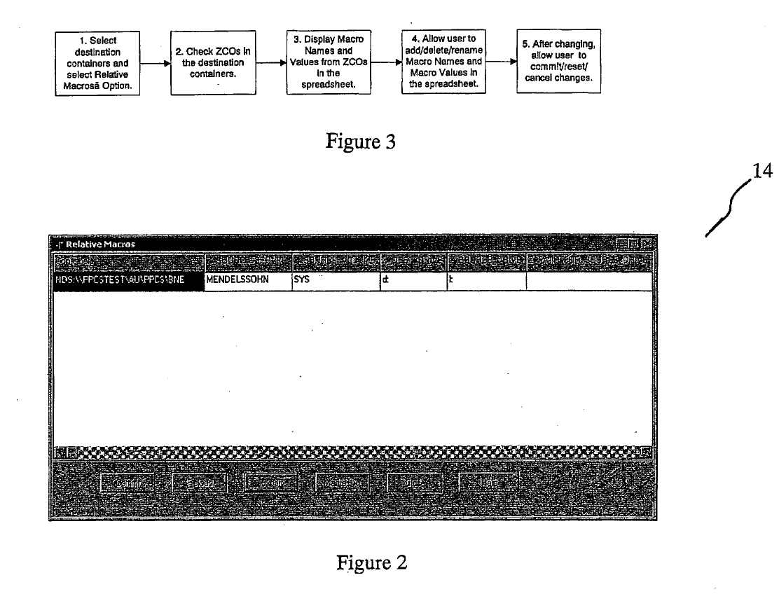

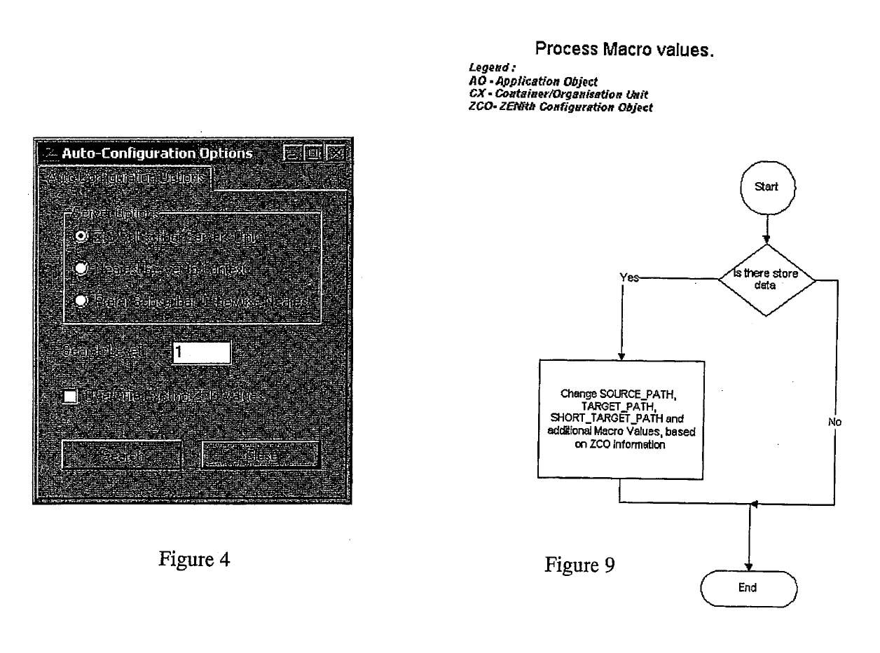

As can be seen in the “selected destination” window 12 the invention provides a “Macro” option for creating and maintaining an object (ZCO) to store some specific information about application objects (AOs) for each container. ZCO is an Application Object that is arranged to keep Relative Macro Names and their values, those information will be created by a user using an entry form 14 (see FIG. 2) in the application that contain a spreadsheet. This form 14 is presented when the “Macro” option in window 12 is elected by the user.

FIG. 3 shows the process steps in selecting destination containers for showing in the form 14. The form 14 also includes options to add/delete/renaming macro names and their values. Specification Details are:

User input list of sites, select containers from destination window

Click on “Macro” button on Selected Destination Window to display Relative Macros™ spread sheet, allow user to add new Macro name (new column) and add value for each site.

Each site that has been assigned with macro value will auto-generate a “ZENith Configuration Object”(ZCO) with the Macro value/s assigned to it

When the applications deploy to the destination site, ZENith will check for the “ZENith Configuration object” & replace the source macro value with the Relative Macro™ stored in the “ZENith Configuration object” in the destination container and finally update the new macro value to the destination Object

Allow user to add & update macro value in the “ZENith Configuration Object”

Button to Commit all changes to the Relative Macros™

Auto configuration Server function to auto search for subscriber, nearest server to context, prefer subscriber otherwise nearest with preset search level to 2 and also verify existing ZCO values

Example:

| | Source | | |
|---|---|---|---|
| | Macro | ZCO Macro | Destination Macro Value/ |
| Macro Name | Value | value | Remarks |
| Z_SOURCE_SERVER | | ABS-2 | [Mandatory Field] |
| Z_SOURCE_VOLUME | | SYS | [Mandatory Field] |
| Z_DEST_DRIVE | | D: | [optional] |
| | | | if this value is not set then |
| | | | the target path same as the |
| | | | source AO's target path |
| Z_SOURCE_DRIVE | | R: | [optional] |
| | | | if this value is not set then |
| | | | the source path same as the |
| | | | source AO's source path |
| Z_PATH_FOR_SOURCE_DRIVE | | Apps | [Optional] |
| | | | contains the path the mapped to |
| | | | the source drive letter in |
| | | | Z_Source_Drive |

Example Relative Macros™:

| Target_Path | C:¥Progra^{˜}1¥WinApp | Z_DEST_DRIVE: | D:¥ Progra^{˜}1¥WinApp |
|---|---|---|---|
| | | D: | Get the Z_Dest_drive from |
| | | | ZCO |
| Source_Path | \\TestSvr\Data\Apps\appl | Z_SOURCE_SERVER AND | \\ABS-2\SYS\Apps\appl |
| | | Z_SOURCE_VOLUME: ABS-2 | |
| | | and SYS | |
| | S:¥Apps¥appl | Z_SOURCE_DRIVE: | R:¥appl |
| | | R: | |
| GW_SERVER_IP | 10. 10. 10. 3 | GW_SERVER_IP: | 221. 101. 151. 17 |
| | | 221. 101. 151. 17 | |

The general work flow for the relative macro processes is shown in FIG. 3 and is substantially as listed below:

1. Select destination containers and select Relative Macros™ Option.

2. Check ZCOs in the destination containers.

3. Display Macro Names and Values from ZCOs in the spreadsheet.

4. Allow user to add/delete/rename Macro Names and Macro Values in the spreadsheet.

5. After changing, allow user to commit/reset/cancel changes.

The Relative Macros™ spreadsheet or form 14 has the following fields:

1. Z_SOURCE_SERVER

2. Z_SOURCE_VOLUME

3. Z_DEST_DRIVE

4. Z_SOURCE_DRIVE

5. Z_PATH_FOR_SOURCE_DRIVE

and controls

Controls

| Function | Shortcut Key |
|---|---|
| Cut | Ctrl + X. Shift + Del |
| Copy | Ctrl + C, Ctrl + Ins |
| Paste | Ctrl + V, Shift + Ins |
| Clear | Del |
| Fill Down | Ctrl + D |

Add, Rename & Remove Macro

Commit Changes

Reset to initial values (Requery NDS)

Add Organisation Unit/s in the site list column

Export Container list & its macro values to CSV file

Auto-Configuration option for Z_SOURCE_SERVER and Z_SOURCE_VOLUME

* Z_SOURCE_SERVER and Z_SOURCE_VOLUME are mandatory fields, Z_DEST_DRIVE,Z_SOURCE_DRIVE and Z_PATH_FOR_SOURCE_DRIVE could be left blank and they will be store as blank. Additional, Macro Names created by users will be stored if they contain data.

TABLE 1.0
Relative Macros ™ details

| | Step | Detailed Description |
|---|---|---|
| 1 | Select Destination | |
| | Container/s | |
| 2 | Check ZCOs in the | (a) Search for the ZCO in the destination container |
| | destination containers. | (FindZCO(container)) |
| 3 | Display Macro Names and | If the ZCO exists for a specific container, |
| | Values from ZCOs in the | Then display in the spreadsheet the entire |
| | spreadsheet | information store in App: Macro field |
| | | (GetMacroNamesandValues (AO)), |
| | | Else display the fields empty. |
| 4 | Allow user to | Users only can add, delete and rename user's Macro |
| | add/delete/rename/Auto- | Names, Default ZCO Macro Names can not be renamed or |
| | Configure Macro Names and | deleted. Auto-configuration option is based on ZfS |
| | Macro Values in the | functionality, and look for Subscribers or Server to fill |
| | spreadsheet. | Z_SOURCE_SERVER and Z_SOURCE_VOLUME Macro |
| | | values. Additionally, users can set the level of searching |
| | | and choose if they want to overwrite existing information. |
| 5 | After changing, allow user | 1. When committing, save Macro Names and Values into |
| | to commit/reset/cancel | the ZCO |
| | changes. | 2. Do the same process (Step 6) for each destination |
| | | container. |
| | | 3. When resetting changes, requery NDS for Macro |
| | | Names and Values. |

Object Naming

Every new ZCO object auto-created in the NDS will be follow the naming convention as below:

| Object | Object Name |
|---|---|
| Application Object (ZCO) | ZENith Configuration |

ZCO Specification

Every new ZENith Configuration object auto-created in the NDS will contain the follow fields:

| Field | Explanation | Example |
|---|---|---|
| Z_SOURCE_SERVER | Contain the server's name for that | Handel, Mozart, |
| | specific container | F1SERVER, |
| | | SERVER 1 |
| Z_SOURCE_VOLUME | Contain the server's volume of the | VOL,SYS,DATA |
| | source server | |
| Z_DEST_DRIVE | Contain a drive letter where the apps | C:,D:,E:,F: |
| | files will be installed on the workstation | |
| | by ZfD | |
| Z_SOURCE_DRIVE | Contain a drive letter where the apps | S:,F:,T:,Z; |
| | files are for being installed by ZfD | |
| Z_PATH_FOR_SOURCE_DRIVE | Contain the path for the source drive | Programs\Apps, |
| | (Use for ZfS) | Apps\ |
| | (If you have an app that has a source | |
| | path eg: s:\MSOffice, with this field | |
| | ZENith will look for the apps files on | |
| | \\Z_SOURCE_SERVER\Z_SOURCE_VOL- | |
| | UME\Z_PATH_FOR_SOURCE_DRIVE\ | |
| | MSOffice | |

Coding Module Design

Following is the pseudo code design for Relative MacroS™ in ZENith 2.50.

Procedure Get_Macro_Value (AO)

Begin

Find_AO (Selected AO List)
If AO exist then

SaveField ValueToFile()

Else

Return AO not exist

Search For Macro Name
If Macro Name exist then

Retrieve Macro Value
Return Macro Value and Macro Type

Else

Return Macro Name not exist

End

Procedure FindZCO(Container)

Begin

Find_AO (AO)
If ZCO exist then

SaveField ValueToFile()
Return File

Else
Return ZCO not exist

End;
Procedure
Set_MacroName_MacroValue(Macronames, MacroValues, MacroType, File, File_Operation)

Begin

If File_Operation is create then

Create file and store header

Else

Open file

case MacroType

String:

Save StringMacro(parameters)

Prompted Drive:

Save Prompted Drive(parameters)

Prompted String:

Save PromptedString(parameters)

End;

Procedure Get_Macros (AO)

Begin

Find_AO (Selected AO List)
If AO exist then

SaveFieldValueloFile()

Else

Return AO not exist

Search For Macros
For each Macro Name return Macro Names and Macro Values

End;

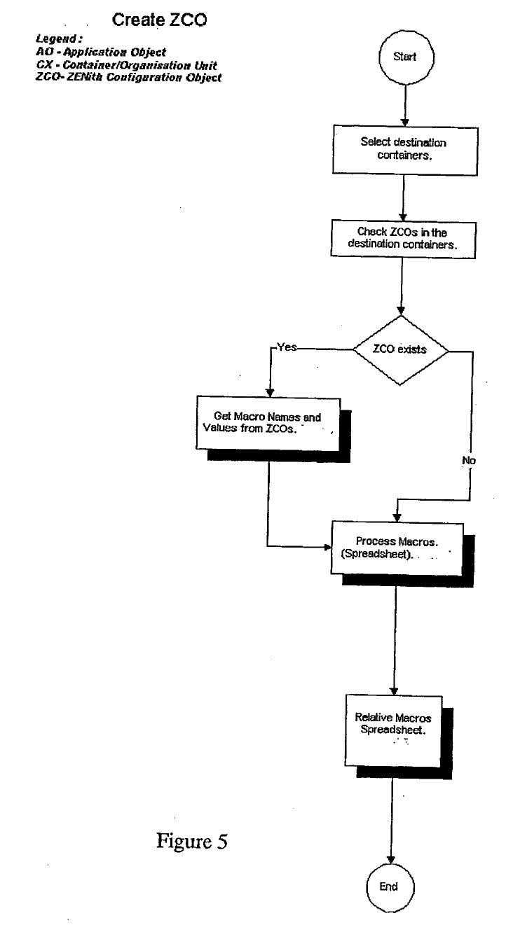

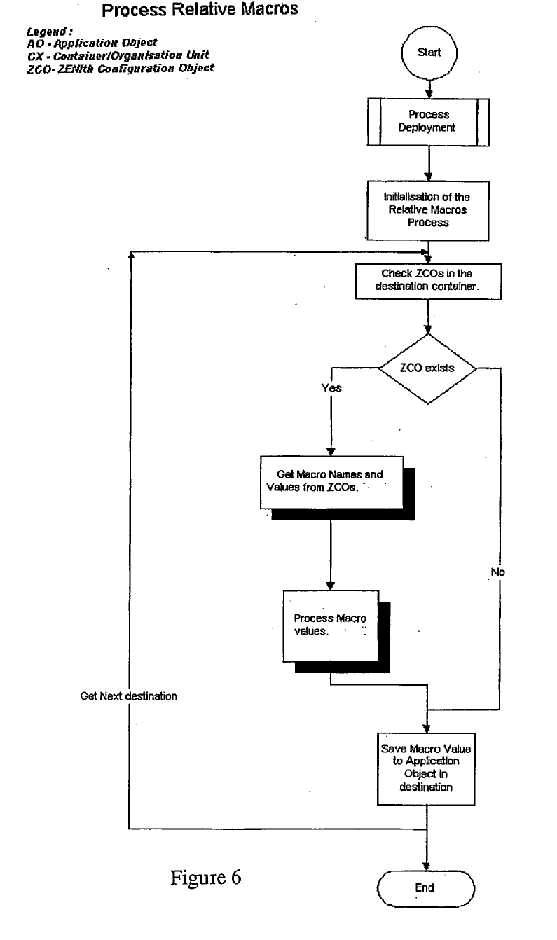

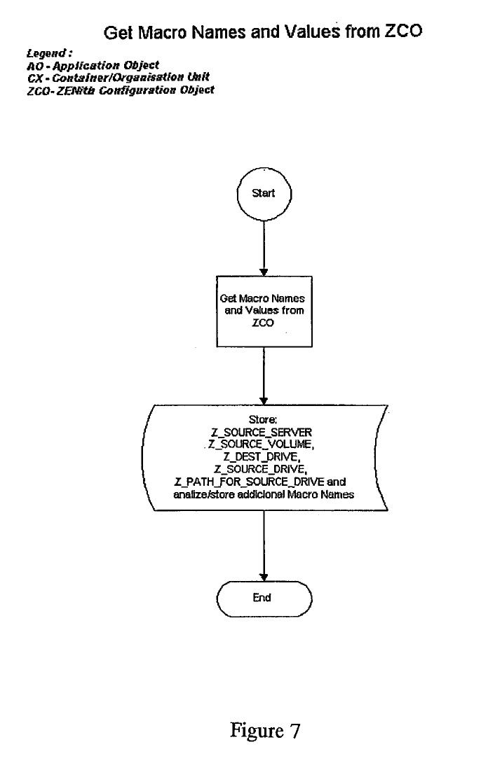

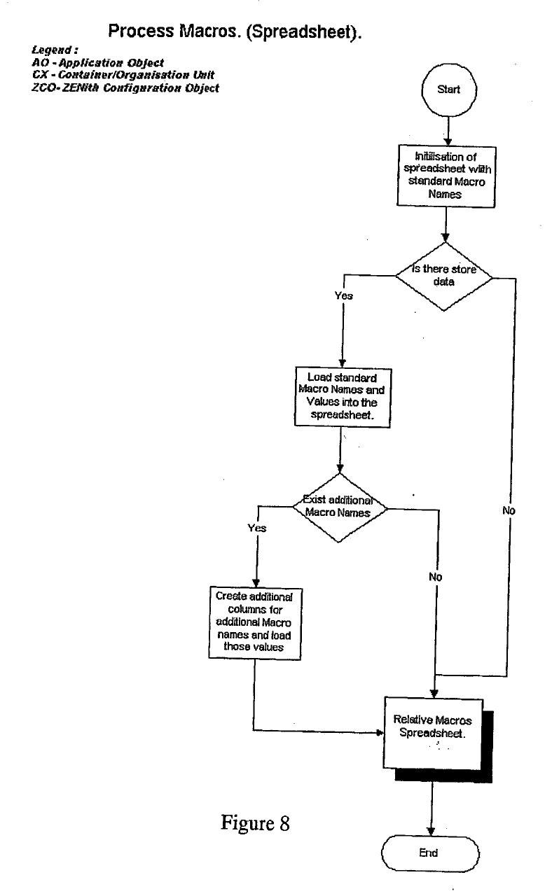

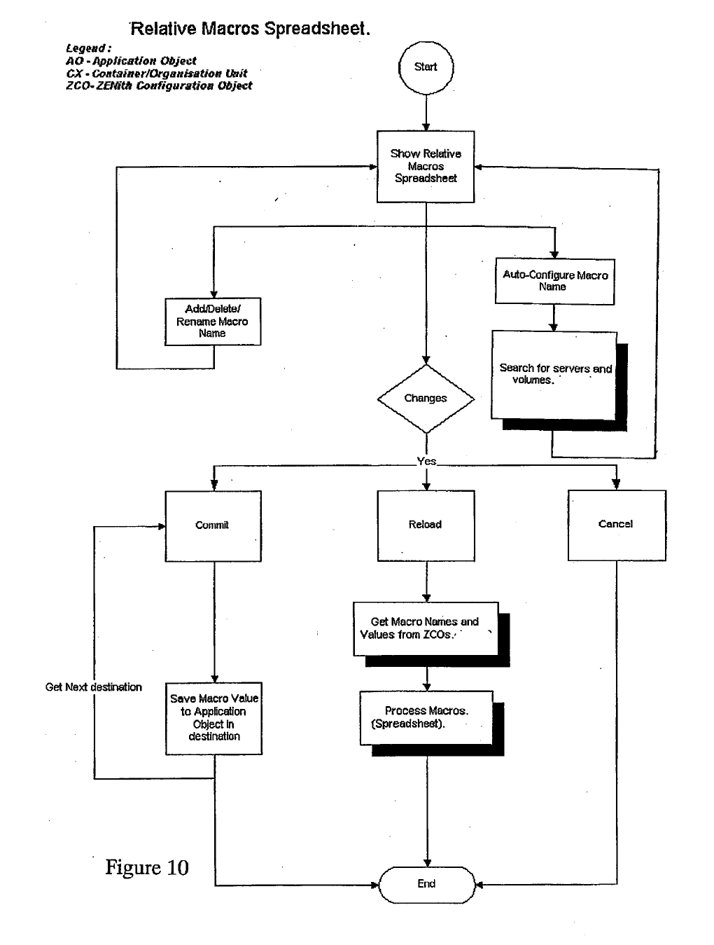

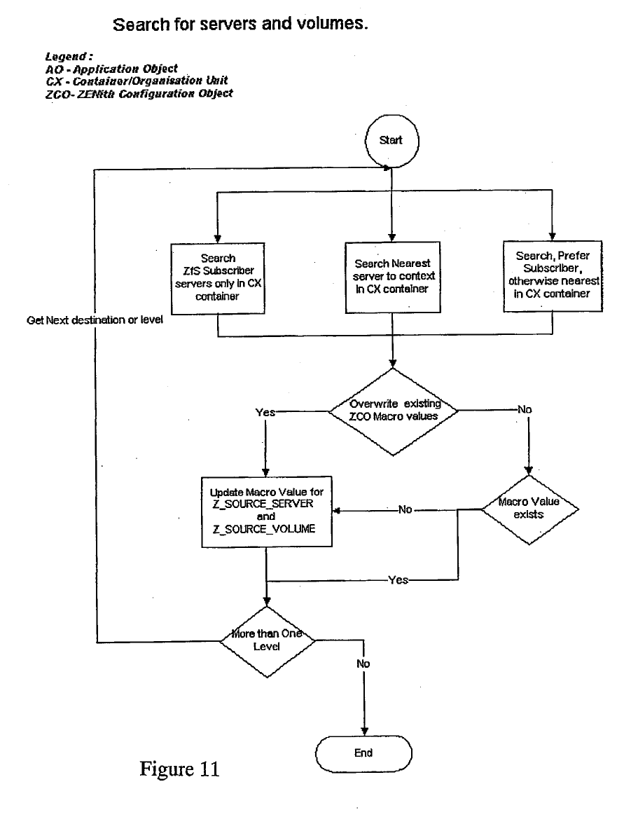

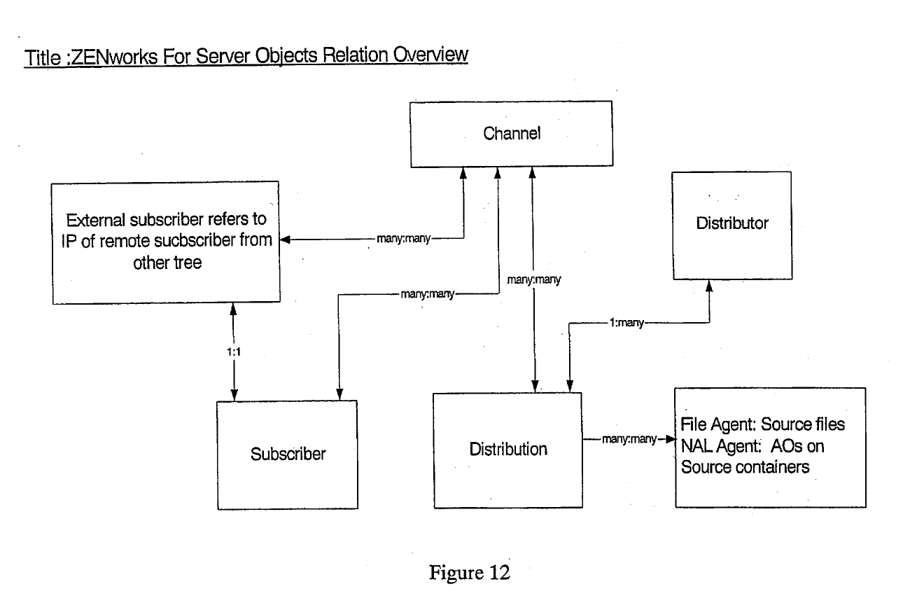

FIGS. 5 to 11 show the processes of the utility for crating and maintaining relative macros The processes are described therein.

The system of the present invention is described with reference to the following non-limiting embodiment. This embodiment uses ZENwork for Servers (ZFS) objects and TED components in deployment: distributor object, subscriber object, external subscriber object, distribution object and channel object. Basically, the embodiment of the invention uses file agent to distribute application files (*.fil) for selected application objects for each destination container, set up Distribution object and channel with the selected destination containers. When files are distributed successfully to the destination through file agent, the system deploys application objects to the destinations. However, administrator has the option to turn off the option to deploy with ZFS or deploy if it is available.

To deploy with ZFS, the system allows the administrator to select applications from multiple containers in multiple trees to multiple containers in multiple tree. Channel and Distribution objects are created per distributor found for the deployment. For cross tree deployment, the external subscriber is created if not found on the source tree.

Source path of the application files, source volume and source server information needed are automatically extracted from macro value of application object or ZCO in source or destination container. These values are used in the distribution file agent to determine the source files, target volume, distributor and subscriber for ZFS deployment. The number of distributor used in the deployment determines the number of distribution and channel objects will be created. However, if the distributor or subscriber not found for application or destination container, the system allows administrator to edit the server name manually, skip the application or entire deployment, process the deployment without copying files and deploy without process associations. Hence, ZENith allows user to deploy objects with ZFS and normal system deployment with options. Introducing to ZFS NDS objects

For better understanding of the relationships of various components of TED, a detailed description for each object is extracted from Novell's ZENworks for Server 2 Administrator's Handbook by Ron Tanner and Brad Dayley.

| | Object Name | Description |
|---|---|---|
| 1 | Distributor object | It holds the configuration information for distributor that |
| | | distributing files to the subscriber and it calls on some TED agents |
| | | to collect the files and bundlers them into a distribution that can |
| | | be sent to the subscribers. |
| | | Note: With ZENith v2.50 , we will only used NAL agent to |
| | | distribute application object only |
| 2 | Subscriber object | It contains configuration information used by subscriber for |
| | | receiving software distributions from the distributors or parent |
| | | subscribers. |
| 3 | External Subscriber | It refers to a subscriber that is outside the distributor's tree and |
| | object | used to enable TED to distribute across tree boundaries. It |
| | | contains the remote subscriber's IP address. |
| 4 | Distribution Object | It represents the collection of files or applications objects that |
| | | transmit as a bundle across the network to various subscribers. A |
| | | distribution is owned by a single distributor that responsible for |
| | | collecting, packaging, and distributing all the files listed in the |
| | | distribution object. |
| 5 | Channel Object | It represents a set of distributions and subscribers that are grouped |
| | | together. All subscribers associated with the channel receive the |
| | | distributions that associated with the channel. |

The following are the descriptions of the relationships of the various components of TED:

1. Distributors are associated with distributions. The same distributor sends the distribution, regardless, to any of the subscribers (or parent subscribers) that will be receiving the files. Distributors are only indirectly associated with subscribers or channels because the distributions (to which distributors are associated) are associated with channels and the channels know the subscribers. Currently, the files that are going to be bundled in a distribution must be on the distributor that is handling the work or accessible via FTP or HTTP from the distributor server (depending on the TED agent used). Subscribers are associated with channels. A subscriber may be associated with many channels and receive all the distributions that are placed in each of the channels to which it is associated.

2. Parent subscribers are identified as a parent either in the routing hierarchy list in any distributor object or as the parent subscriber in any subscriber object

3. Channels are a collection of distributions and subscribers. Subscribers and distributions are associated with the channel. Essentially, the channel describes a set of subscribers that should receive the set of distributions. Distributions from many distributors can be placed in a single channel.

4. Distributions are collections of files that are sent in the TED system. Each distribution belongs to a single distributor and can be placed in multiple channels. A distribution may be placed in any number of channels, and the distributor is responsible for sending the distribution to all of the subscribers that are subscribed to the channels.

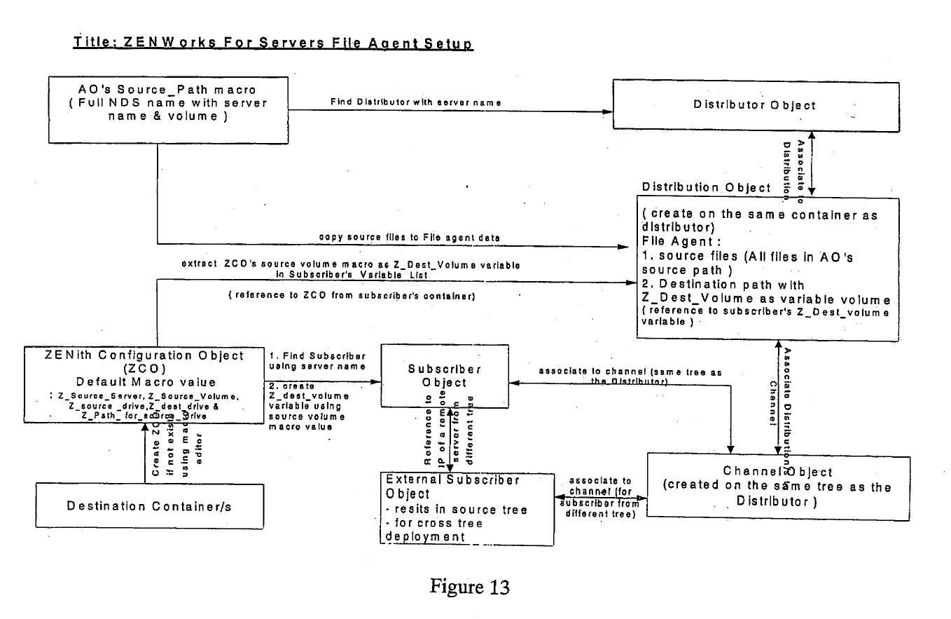

FIG. 12 shows an overview of the known ZENWorks server relation.

Pre-Deployment Check List

The following are the error control list prior to application deployment. If the deployment does not meet with the criteria, options may be display to determine the next action or getting input from administrator and there are some predefined action in the deployment options.

1. Source and destination server/container must be installed with ZFS v2.00

2. Destination container MUST not be source object's sub-tree container

3. Destination container must has a subscriber object in the same container or its parent container

4. Application Object selected must has a distributor object in the same container or its parent container that match with the Source Server information extracted from Macro value

5. If destination container is from a different tree from selected Application Objects, it must has a subscriber object that reference by an external subscriber object in the distributor's container or its parent container.

6. Selected application objects grouped in the Distribution object MUST be from single tree and associated with the same distributor object which represent the source server.

The selected applications must be separated into groups sorted by distributor name. Subsequently, each group will form its own distribution object's file distribution list.

Prompt error if the distributor can not be determine by source_path macro value's server name.

The macro value can be obtained from AO's macro field or ZCO in the source container

It is recommended to turn on the “Process Relative Macro” option to update the application's source path as the target volume of the file agent is based on ZCO's source volume.

Deployment Process

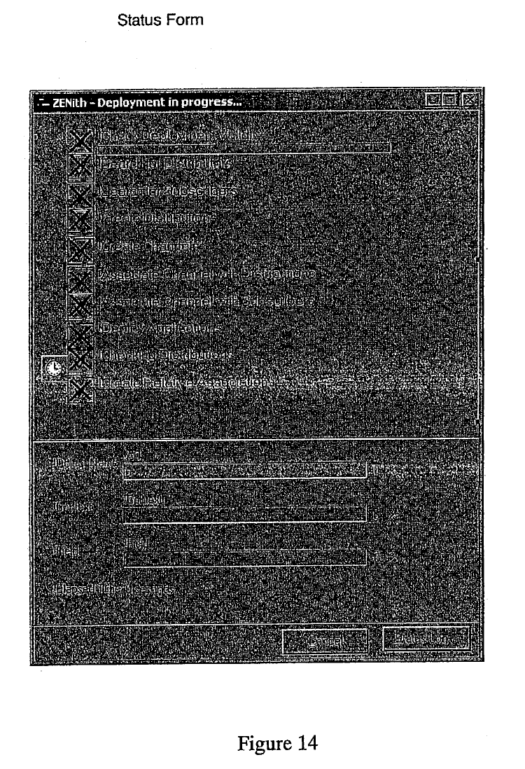

General work flow only describes the single process for ZENworks For Server Objects deployment, it does not includes error checking and pre-requisite checking with different scenarios. Table 10.0 and FIG. 13 provide ZFS deployment details.

General Work Flow

1. Select source application objects from single or multiple containers in a single or multiple source tree.

2. Select destination containers from single or multiple containers in multiple tree

3. Find distributor for all selected applications, group them into virtual distribution groups. Note: Those applications without distributor may be deploy as per normal depends on the action choose by user when error prompt for action.

4. Create Distribution Object for source applications from the same distributor in their distributor container.

5. Add Z_Dest_Volume variable for target volume in file agent, hence different subscriber may have their individual define target volume that is corresponding to the source path macro in destination applications.

This variable must be defined in Subscriber 's variable list, it extracts the Z_Source_Volume macro from ZCO.

If ZCO does not exists it will used the default volume “SYS”.

If Z_Dest_Volume variable does not exists in subscriber, it will be created.

6. Extract the source path macro from source applications to determine the target application files in distribution's file agent.

7. Associate distributor to Distribution object and set up the TED file agent for applications in the same distribution virtual group.

8. Create channel object for source applications in their distributor container, deactivate the channel

9. Associate channel object to subscriber object of destination containers

10. Associate channel to Distribution objects created in step 4

11. Activate channel and schedule to run immediately

12. Run the ZENith objects deployment without deploy associations.

13. Awaiting for the ZFS file distribution process completed successfully, deploy associations.

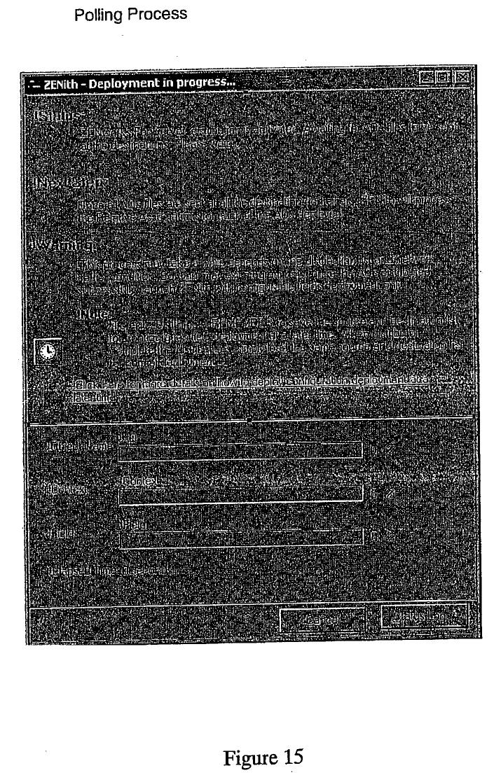

FIG. 14 is a form showing current status of the deployment process.

Once the channel object is activated, the ZFS process will start distributing files to the subscribers, another message window will display the ZFS process is in progress and prompt user about the potential delay time and allow user to intervene or skip the AO deployment. When the application distribution completed, the normal deployment status form will be shown to continue deploy to the destination container.

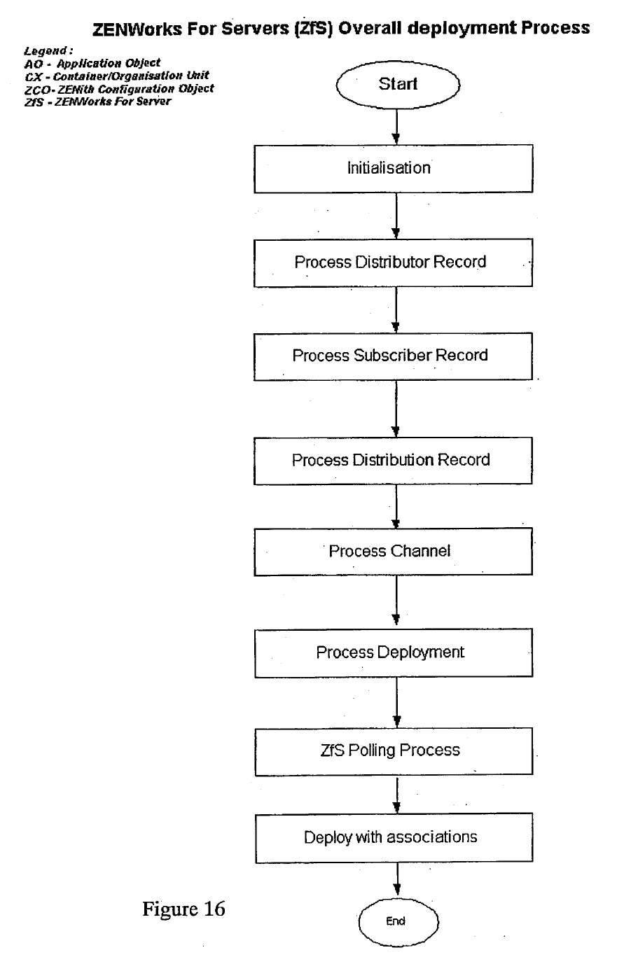

FIG. 15 shows an example of a ZFS message window.

Table 10.0: ZFS Deployment Details

Remarks: Options for action, please refer to Table 12.0 Actions

| | Step | Detailed Description |
|---|---|---|
| 1 | Select Application object/s | (a) Find the AO's distributor by Source_Path from ZCO or |
| | | AO's macro value. |
| | | (b) If no Source_Path macro value return, report error |
| | | (c) Report error if distributor object does not exists |
| | | (d) Prompt options for AO without distributor |
| | | (e) Grouped the AO into virtual groups by AO that |
| | | associated with the same distributor object. |
| | | (f) Total number of virtual group determines the number |
| | | of Distribution and Channel object to be created in |
| | | the same container as the distributor. |
| | | (g) Each virtual AO group will form a file distribution list |
| | | once a Distribution object created with TED File agent |
| | | activated. |
| 2 | Select Destination | (a) Find the subscriber from ZCO's Z_SOURCE_SERVER |
| | Container/s | (b) If ZCO not exists or Z_SOURCE_SERVER returns |
| | Note: | empty value, prompt error and options for actions. |
| | Same source tree as | (c) Ensure the subscriber exists in the same tree as the |
| | distributor then use | destination |
| | subscriber from the same | (d) Log error & prompt options for action |
| | tree | (e) If the destination is from different tree from the |
| | If deploy cross tree then it | selected AO then , it must have the external subscriber |
| | use external subscriber in | object in the distributor's tree. Find the subscriber |
| | distributor's tree and | using step from (a)-(c), get the server IP and match with |
| | subscriber in their own tree | External subscriber from source Tree, the matching |
| | | external subscriber will be added to the channel. |
| | | (f) For destination from different tree, if no external |
| | | subscriber found, remove it from the destination list |
| | | and log error. |
| 3 | Other deployment validity | (a) Both source & destination have ZFS v3.2 |
| | | (b) if option to display distribution list is on, display the |
| | | list and update any changes user made |
| | | (c) ensure the options for ZFS deployment is on |
| 4 | Save Deployment Record | (a) Save the record of ZFS deployment list and normal |
| | | deployment list if any |
| 5 | Start Deploy | If no error found in preliminary checking, proceed to |
| | | create and set up the ZFS file agent |
| 6 | Create Distribution object | Create Distribution object based on the virtual group form |
| | in Distributor's container | in step 1 into their distributor's container |
| | | e.g If there are x virtual groups, hence there will be x |
| | | number of distribution objects created in the container |
| | | where their server's distributor resits |
| | | Create Distribution per distributor |
| 7 | Set up file agent of | (a) Get the source files of applications from each virtual |
| | Distribution object | group to associate to their respective Distribution |
| | | object created in step 6 |
| | | (b) Assign target volume using variable |
| | | % Z_Dest_Volume % that is defined in subscriber's |
| | | variable list. |
| | | (c) Create Z_Dest_volume variable if it does not exists in |
| | | subscriber's variable list. The target volume will be |
| | | extracted from the ZCO's Z_source_volume macro or |
| | | use default “Sys” volume if no ZCO found in |
| | | destination container. |
| 8 | Create Channel Object in | (a) multiple channel objects for each distributor |
| | Distributor's container | (b) deactivate channel object |
| | | (c) may includes cross tree distributions with external |
| | | subscriber defined in source tree |
| 9 | Associate Channel to all | including subscriber and external subscriber |
| | Subscribers in destination | |
| | containers | |
| 10 | Associate Channel to all | Create channel per Distributor |
| | Distribution objects in the | |
| | same Distributor's path | |
| 11 | Activate Channel | (a) ZFS perform deployment |
| | Note: ensure schedule is | (b) Close ZFS status form |
| | run immediate for all | (c) Constant polling to check the files has been copied to |
| | objects | the destination path.(e.g number of files & bytes) |
| | | (d) Display a message form with the following |
| | | information |
| | | 1. Status of ZFS deployment is in progress |
| | | 2. Warning about the ZFS deployment may take a |
| | | while if deploy across partition or slow link |
| | | 3. Describe next step of AO's e fields deployment in |
| | | brief, provides links to help file for detailed |
| | | description |
| | | 4. Recommended action if user do not want to wait |
| | | for ZFS distribution completion and wants to |
| | | deploy the configurable fields in a separate normal |
| | | deployment, provide links to help file for detailed |
| | | information |
| | | 5. Cancel button for user to skip AG deployment |
| | | once the ZFS is in progress. |
| 12 | AO deployment | (a) When ZFS completed the file distribution successfully, |
| | | it should initiate the fields deployment |
| | | (b) For deployment with ZFS, “App:Copy Files |
| | | “App:Copy Files Always” field must be copied to the |
| | | destination |
| | | (c) User may stop the process at any time |

Options

TABLE 11.0

| | Option | Details |
|---|---|---|
| 1 | Deploy with ZFS | (a) Default option is off. |
| | | (b) to deploy application objects with ZFS |
| | | objects. |
| | | If the option is unchecked it will deploy objects |
| | | as normal ZENith deployment. |

User Input

### Server Name for Distributor and Subscriber

Distributor should be derived from the Source Server or source path macro value extracted from either application object or ZENith Configuration Object (ZCO). Subscriber is only depends on the Source Server macro value defined in ZCO. If no server name can be determined then an error message dialog box will be display with list of corrective actions. User may select one of the following actions.

TABLE 12.0
Actions

| | Action Name | Function |
|---|---|---|
| 1 | Do not copy those application | Skip the application/s whereby the |
| | | distributor can not be found |
| | | Skip the destination whereby the subscriber |
| | | can not be found |
| 2 | Copy application but don't process | deploy normal ZENith application |
| | Relative Association ™ | deployment without processing the association |
| | | field |
| 3 | Process as normal, disregarding file | same as do not deploy with ZFS option |
| | copying | choose |
| | | deploy normal ZENith application |
| | | deployment as usual |
| 4 | Cancel whole deployment | Cancel deployment |
| 5 | Edit server names now | Launched ZCO macro value editor for user to |
| | | enter the server name |

Object Naming

Every new TED object auto-create in NDS will be follow the naming convention as below:

X—sequential number

| Object | Object Name |
|---|---|
| Channel | Z_Channel_X |
| Distribution | Z_Distribution_X |
| External Subscriber | Z_ExtSubscriber_X |

Other than object, there will be a destination volume variable used in the subscriber and distribution object with a fixed name Z_DEST_VOLUME, so that it can be referenced by all subscribers in the channel to reference to their target volume.

Duplicate ZFS TED Objects Handling

Duplicate Channel object

If administrator selects to create new channel in the selected container ZEN, if the container already has channel object Z_Channel_{—}1, ZENith simply create a new channel object by increasing the sequential number Z_Channel_{—}2.

If administrator select an existing channel, the current distribution list's subscribers and distributions will be appended to the channel. The channel will be de-activate until all the ZFS configuration completed.

Duplicate Distribution Object

ZENith will assigned the distribution object according to sequential number. Hence if distribution object already exists then ZENith simply create a new distribution by increasing the distribution sequential number in the naming format. Each deployment will create new distribution unless user change the distribution list displayed by selecting existing distribution object prior to deployment.

Using any existing distribution object will de-associate from its existing distributor and it will be assigned to the new distributor in the distribution list record.

Example:

Z_Distribution_{—}1, Z_Distribution_{—}2 already exist in the ZEN container, then the new distribution object name assigned will be Z_Distribution_{—}3.

Deployment Scenario

1. Single Tree Deployment with a distributor and a subscriber

2. Single Tree Deployment with multiple distributor and multiple subscriber

2.1. Contains proxy subscriber

2.2. Direct subscriber only

3. Cross Tree Deployment

3.1.with a distributor, a subscriber and a external subscriber

3.2. with multiple distributor, multiple subscriber and external subscriber

3.2.1. contains a proxy subscriber

3.2.2. Direct subscriber only

4. Duplicate Object Handling using existing External Subscriber

Testing Environment Set Up

TABLE 2.0
Server Set up

| Tree Name\Server | Role | Remarks |
|---|---|---|
| TestTree 1\Server_A | Distributor | |
| TestTree_1¥Server_B | Distributor | |
| TestTree_1\Server_B | Subscriber | Subscribe to proxy subscriber, |
| | | application distribute through |
| | | TestTree_1\Server_C proxy subscriber |
| | | instead of directly from distributor |
| | | Server_A |
| TestTree_1\Server_C | Subscriber | subscriber for Server_A & Server_B |
| | (Proxy Subscriber) | define in routing hierarchy to act as |
| | | parent subscriber for subscriber |
| | | TestTree_1\Server_B |
| TestTree_1\Server_D | Subscriber | Subscribe directly to distributor Server_A |
| | | and Server_B |
| TestTree_2\Server_E | Subscriber | Subscribe to Server_A & Server_B from |
| | | TestTree_1 through External Suscriber |
| Created on the TestTree_1 | External Subscriber | External Suscriber refers to subscriber |
| | | from |
| | | TestTree_2\Server_E |

Note:
TestTree_1\Server_B is a distributor and subscriber

Coding Module Design

Following is the pseudo code design for ZENWorks for Servers deployment in ZENith. Please note that it is the actual coding but a reference module.

Procedure Deploy_ZFS( )
Begin

Display ZFS deployment progress status;
If Pre_Deployment_Error_Check failed then

Exit;

Save all ZFS deployment details into record;
Create Distribution Object based on the record stored;
Associate Distribution Object with all AO's source files and destination path;
Process Channel;
Display ZFS deployment progress dialog;
Polling process to check destination file size & number of files;
If ZFS process completed then

Deploy AO as per normal;

End;
Function Pre_Deployment_Error_Check ( ):boolean;
// Remarks: At this point, the objects has not been created yet, hence user may change the association if they
wish // to link to another existing object.
Begin

Find_Distributor (Selected AO List);
Form virtual groups for source AOs use the same distributor;
Find Subscriber(Selected Destination);
Assign distribution name to group all AOs with the same distributor and save to record;
Assign default path for channel object; // first AO's distributor path
If option to display ZFS distribution list then
Begin

| | |
|---|---|
| // | Display ZFS deployment details if option for display is on for user to made changes; |

Display the ZFS distribution Objects table;
Update changes on Distribution objects table;

End;

End;
Procedure Find_Subscriber (Destination List)
// record refers to Distribution list table entry
Begin

For each destination do
Begin

Server Name := Get_Macro_value “Z_SOURCE_SERVER” from Zenith Configuration Object;
If Server Name found then

Find the subscriber, add to record

Else

Begin

Prompt error and options for action;
Process Actions choose;

End;

For each source tree do
Begin

If destination tree < > source tree then
Begin

Get IP address for the destination tree's subscriber

Find external subscriber in source tree reference to IP found and save to record.

If external subscriber not found then

Log error & remove the destination from the deployment list;

End;

End;

End;

End;
Procedure Find_Distributor (AO_List)
// record refers to Distribution list table entry
Begin

For each AO do
Begin

Server Name := Get_Macro_value from AO or Zenith Configuration Object;
If Server Name found then

Find the Distributor, add to record

Else
begin

Prompt Error and options for actions;
Process Actions choose;

End;

End;

End;
Procedure Process Channel( );
Begin

Associate all subscriber and external subscriber from record to the channel;
Associate all distribution from record to the channel;
Activate all schedule of distribution, subscriber and finally channel;

End;
Procedure Display ZES deployment progress dialog( )
Begin

{Description: This progress dialog display after all the ZES configuration done and distribution is in progress

,there will be warning about the delay in application distributions, configuration field deployment

details and allows user to intercept the process.

}
if user click “cancel” then

exit program;

Polling to check the destination for files distributed by checking the number of files & bytes copied;
If application distributed successfully then

Close this dialog;

End;
Procedure Process Actions choose;
Begin

Prompt error message;
Display option of actions;
Case of Actions

Do Not copy those Apps:

Remove the apps/destination container from deployment list;

Copy apps but don't process Relative Association ™:

Deploy Apps as per normal without relative Association field;

Process as normal, disregard file copying:

Deploy Apps as per normal;

Cancel Whole deployment:

Exit deployment function

Edit Server names now:

Display macro editor; // when exit editor, the changes will be updated on ZCO

End;

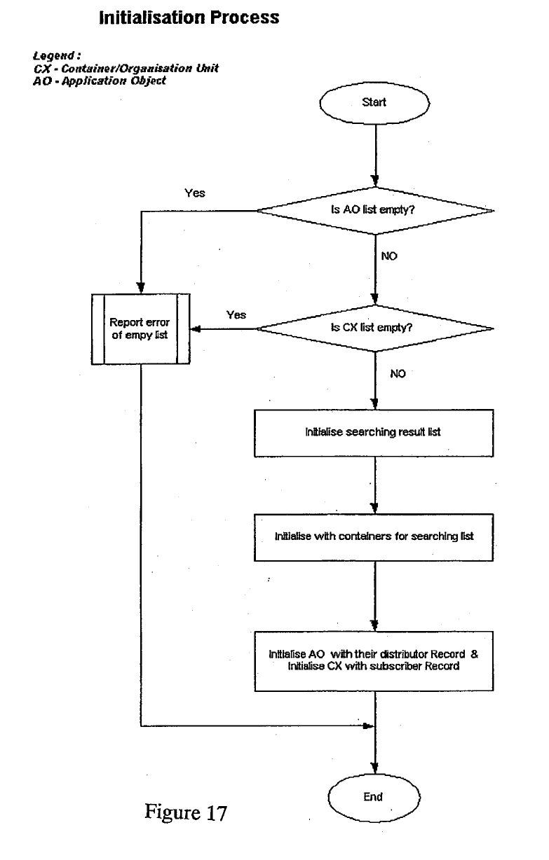

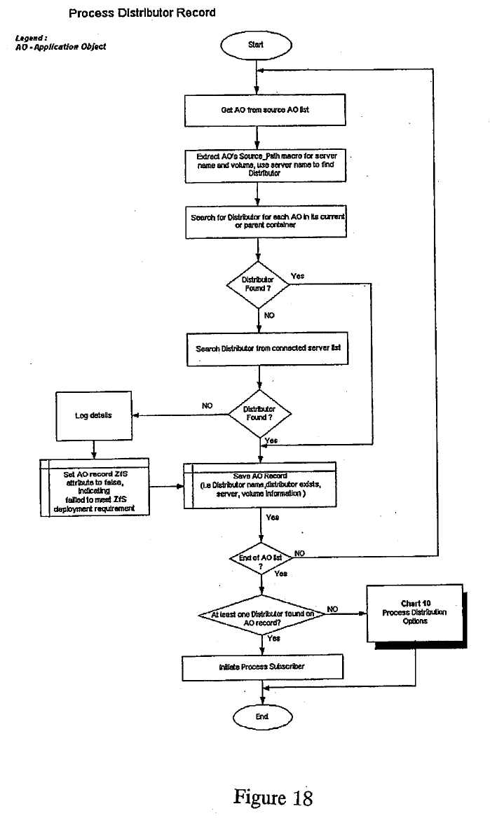

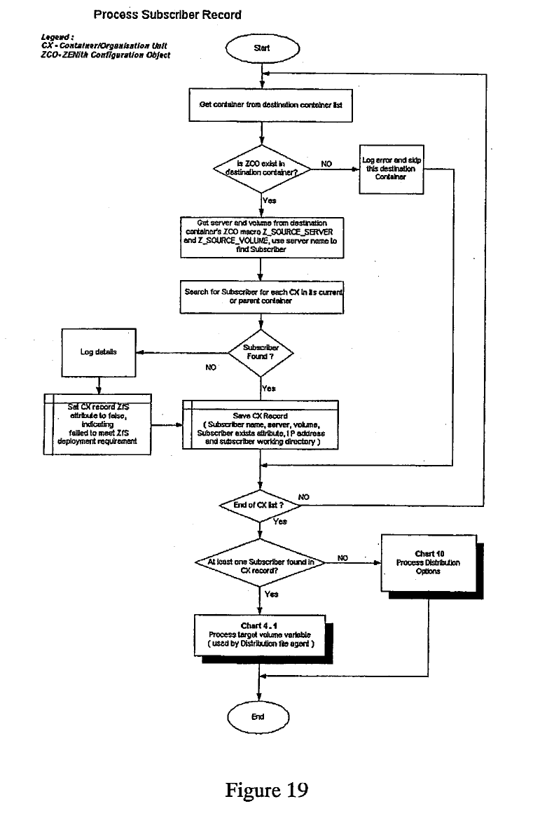

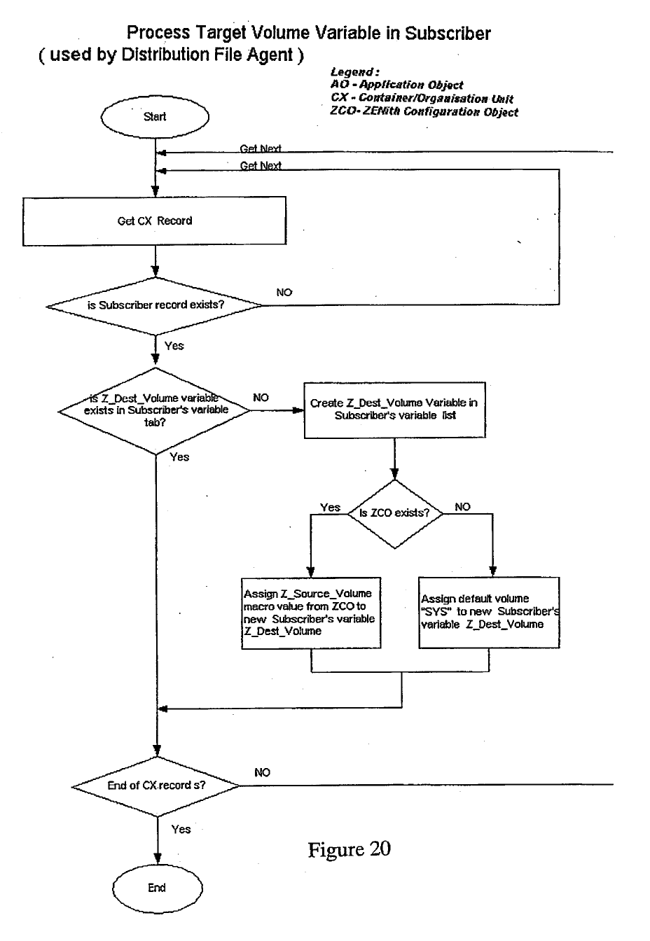

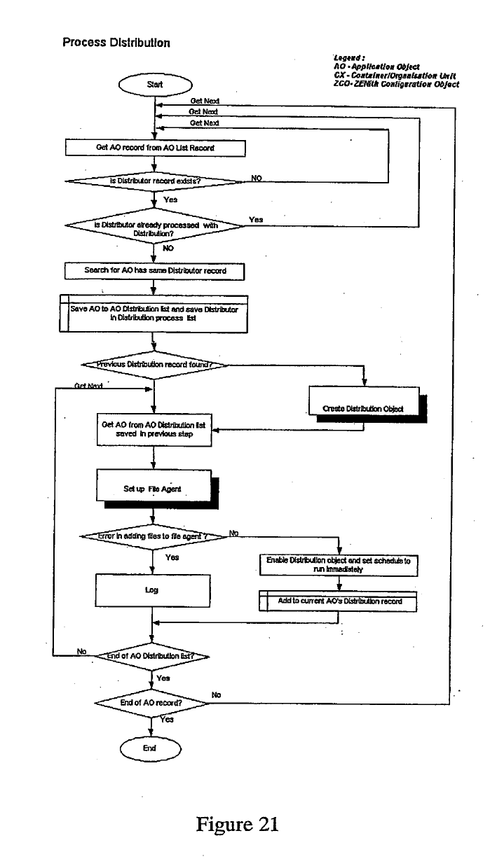

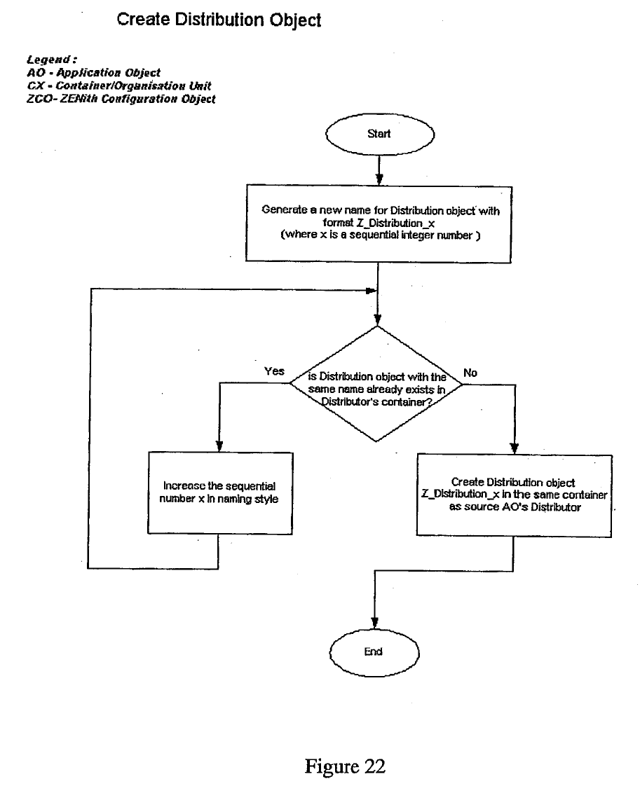

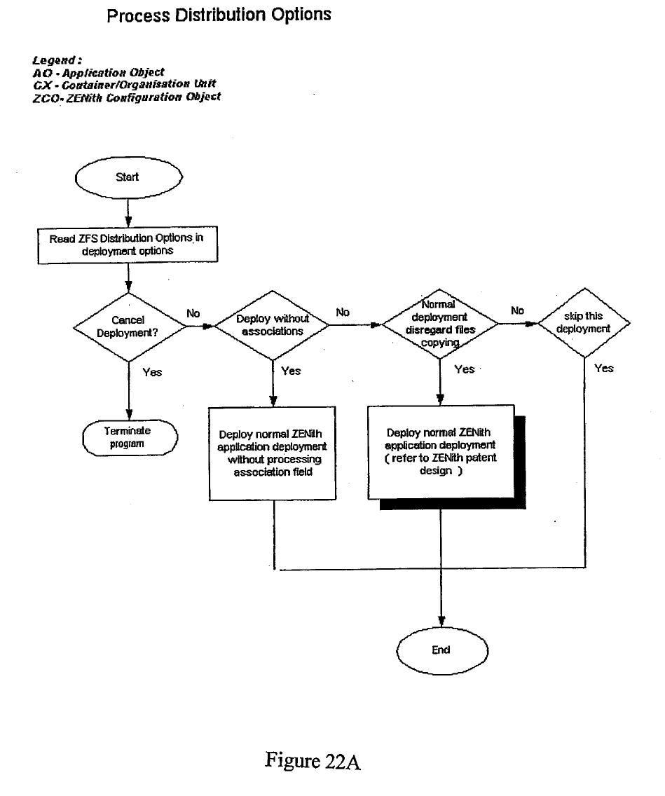

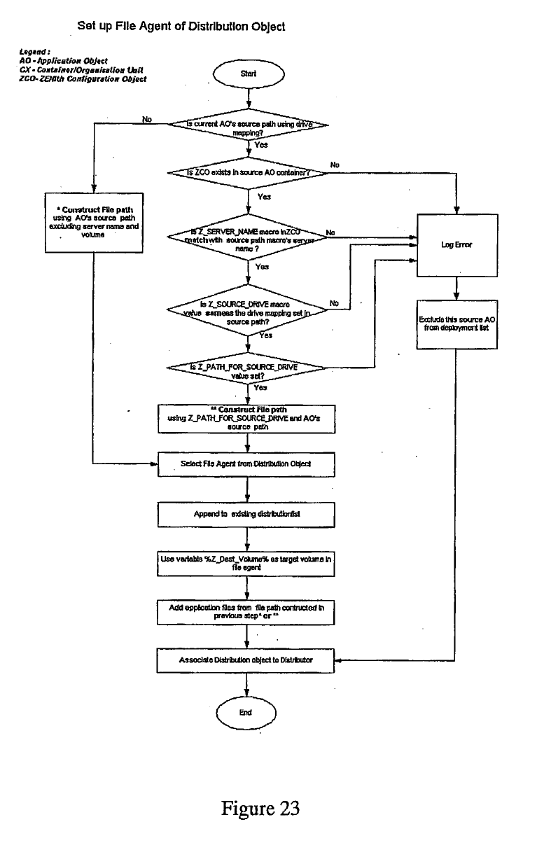

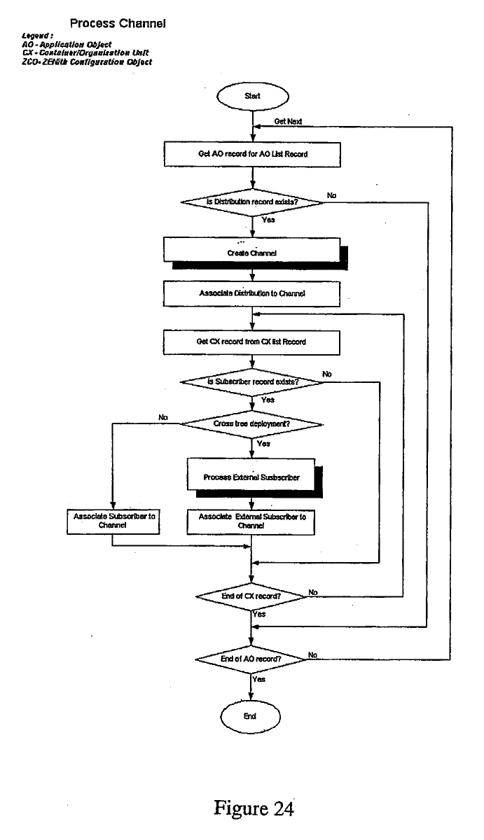

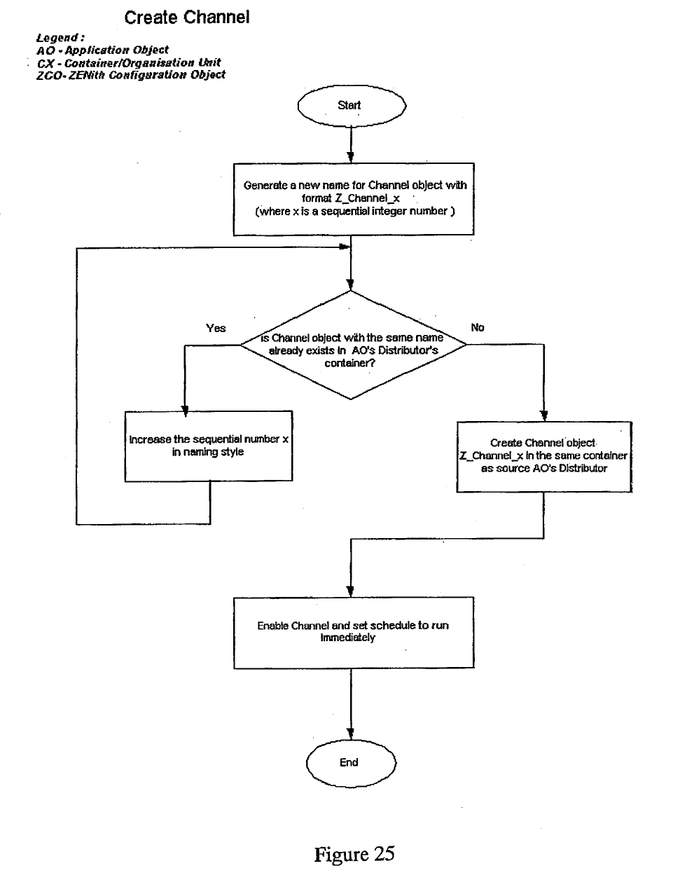

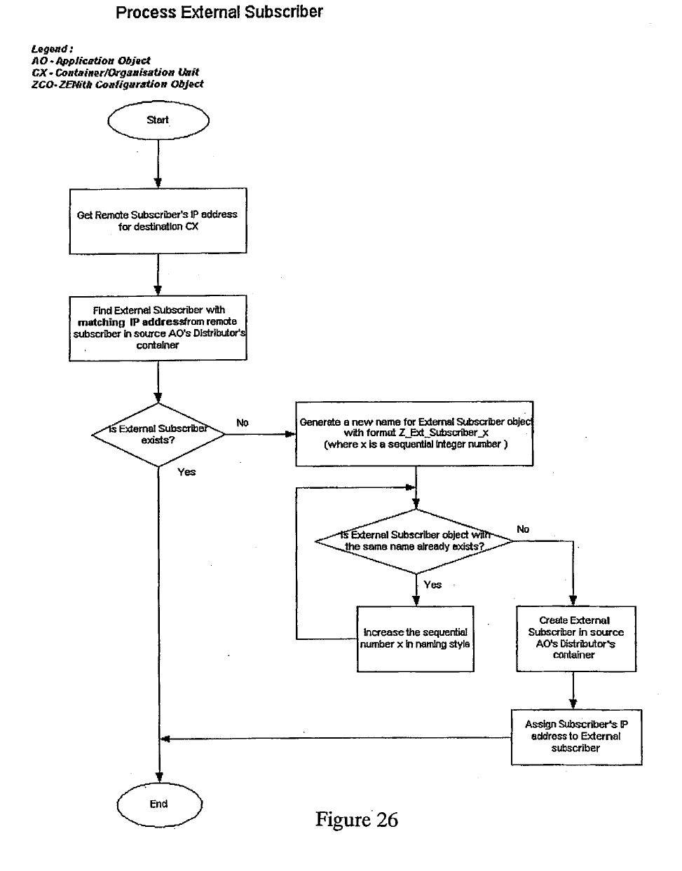

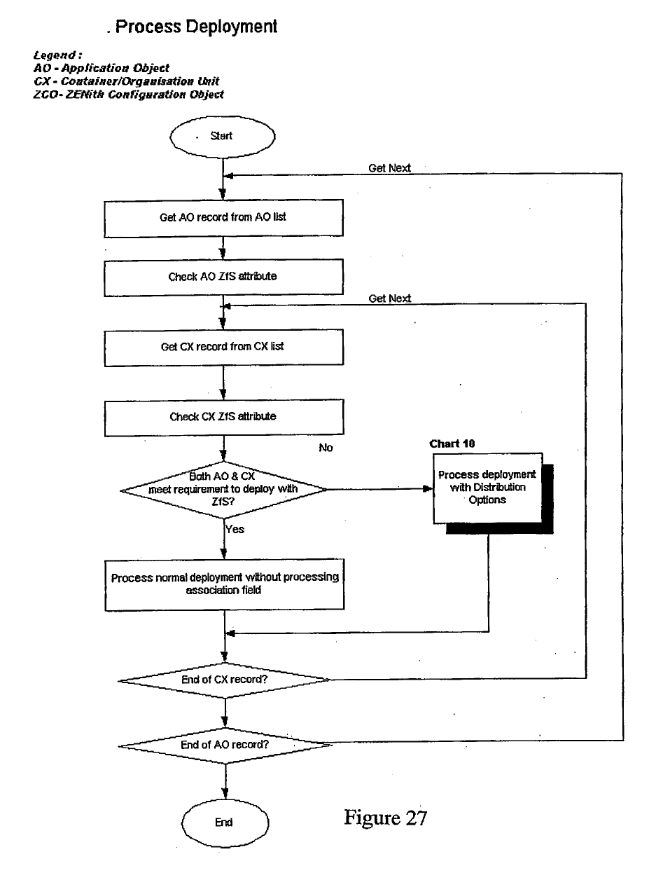

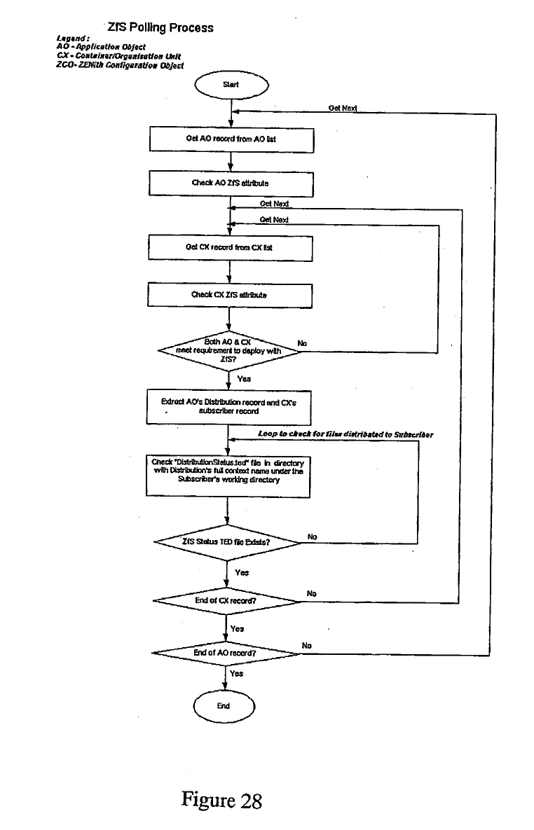

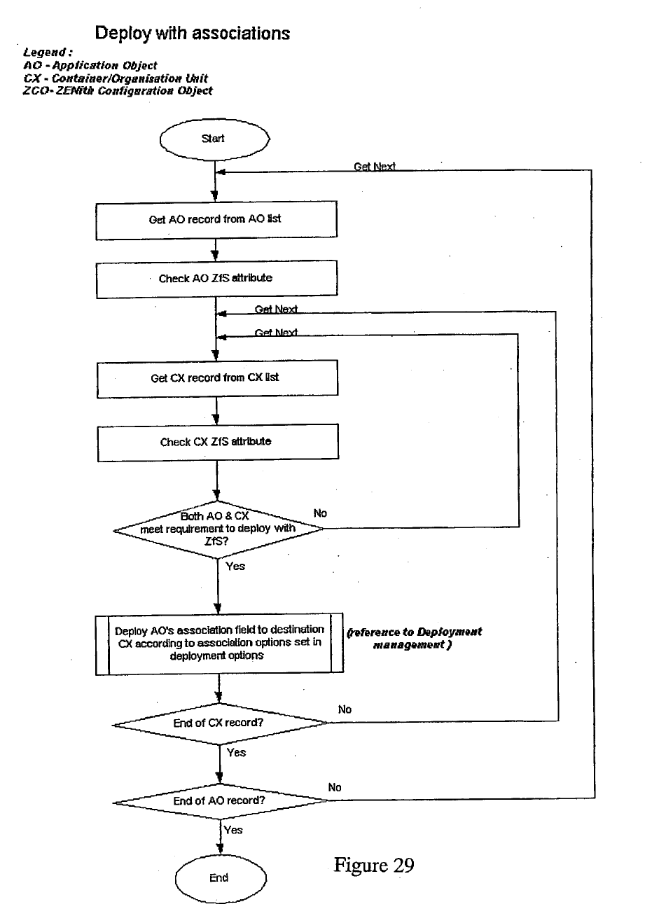

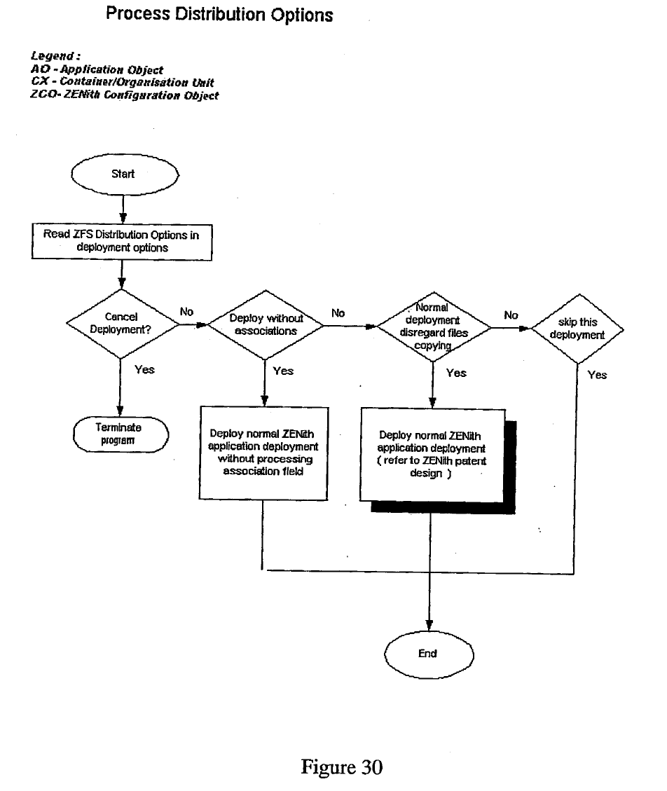

FIG. 16 shows the processes for the embodiment of the deployment system. Details of the processes are shown in FIGS. 17 to 30. As the process steps in these Figures are sufficiently described therein, the applicant believes that the disclosure is sufficient for a skilled person to fully understand the nature of the present invention, no further details of the process steps are necessary.

Whilst the above has been given by way of illustrative example of the present invention many variations and modifications will be apparent to those skilled in the art without departing from the broad ambit and scope of the invention as set out herein.

1. A network administration management utility for a computer network having a hierarchical tree structure, the utility comprising container selection means for selecting one or more containers from destination network sites in said tree structure, assigning means for assigning one or more macro reference for the selected container(s), and means for generating a configuration object (ZCO) having the corresponding macro reference(s) for each assigned container.

2. The utility according to claim 1 wherein said macro reference includes a macro value associated with a macro name, said macro name being a source server name, a source volume name, a destination drive, a source drive, or a path for source drive.

3. The utility according to claim 1 further including updating means for updating the macro reference(s) of the configuration object.

4. The utility according to claim 2 further including object selection means arranged for selecting one or more application objects, means for creating distribution objects based on the source paths of the selected application objects, and means for setting up a file agent having target volumes corresponding to the source volumes of the selected application objects or a default macro value for the volumes, the file agent being arranged for distributing application files for the selected application objects for each destination container to the destinations.

5. The utility according to claim 4 including means for creating channels associated with the distribution objects and subscribers in the destination containers.

6. A deployment system for deploying application objects in an computer network having a hierarchical tree structure, the system comprising:
means for selecting one or more application objects each having a source path and a source volume;
means for selecting one or more destination containers;
means for creating distribution objects based on the source paths of the selected application objects;
means for setting up a file agent having target volumes corresponding to the source volumes of the selected application objects or a default macro value for the volumes; and
means for creating channels associated with the distribution objects and subscribers in the destination containers

7. The system according to claim 6 wherein said application objects selection means being arranged to select source application objects from single or multiple containers in a single or multiple source tree, and said destination objects selection means being arranged to select destination containers from single or multiple containers in a multiple tree.

8. The system according to claim 6 wherein said means for creating distribution objects being arranged to find distributors for all selected applications and to create distribution objects from the same distributors in the distribution containers.

9. The system according to claim 8 wherein said distributors are grouped into virtual distribution groups.

10. The system according to claim 6 wherein said means for setting up a file agent being arranged to add a destination volume variable for a target volume, and to add a source path from source applications to determine target application files in the file agent.

11. The system according to claim 10 wherein said variable is either extracted from correspond macro reference of a configuration object (ZCO) or where the ZCO does not exists a preassigned default variable.

12. The system according to claim 10 wherein where the volume variable does not exists in a subscriber, the system is arranged for creating a volume variable for the subscriber.

13. The system according to claim 6 wherein said means for setting up a file agent is arranged to associate a distributor to a distribution object and set up the file agent for applications in the same distribution virtual group.

14. The system according to claim 6 wherein said means for creating channels is arranged to create channel objects for source applications in their distributor containers, and to associate the channel objects to subscriber objects of destination containers.

15. The system according to claim 6 further comprising a graphical user interface having a window showing a selected object tree and respective object and destination list windows.

16. The system according to claim 6 wherein said volume being extracted from a configuration object (ZCO) generated by a network administration management utility which comprises container selection means for selecting one or more containers from destination network sites in said tree structure, assigning means for assigning one or more macro reference for the selected container(s), and means for generating the ZCO having the corresponding macro reference(s) for each assigned container.
